(19) United States
(12) Patent Application Publication
(10) Pub. No.: US 2015/0302433 A1
(43) Pub. Date: Oct. 22, 2015

(54) Automatic Generation of Custom Intervals

(71) Applicant: SAS Institute INC., Cary, NC (US)

(72) Inventor: Yue Li, Cary, NC (US)

(21) Appl. No.: 14/574,169

(22) Filed: Dec. 17, 2014

Related U.S. Application Data
(60) Provisional application No. 62/011,461, filed on Jun. 12, 2014.
(60) Provisional application No. 61/981,174, filed on Apr. 17, 2014.

(51) Int. Cl. G06Q 30/02

(52) U.S. Cl. CPC G06Q 30/0202

(57) ABSTRACT

Systems and methods for linear regression using safe screening techniques. A computing system may receive a plurality of time series that includes one or more demand characteristics and a demand pattern or an item. The computing system may determine a number of low-demand period within the time series. The computing system may determine a series type for the time series based on the low-demand periods. An in-season interval of the time series may be determined based on the number of low-demand periods and the series type. A future in-season interval of the time series may be derived based on the in-season interval.

### CROSS-REFERENCE TO RELATED APPLICATIONS

The present disclosure claims the benefit of priority under 35 U.S.C. §119(e) to U.S. Provisional Application No. 61/981,174, filed Apr. 17, 2014 and titled “Classifying and Grouping Demand Series,” and U.S. Provisional Application No. 62/011,461, filed Jun. 12, 2014 and titled “Automatic Generation of Custom Intervals,” the entireties of which are incorporated herein by reference.

This application is also related to and incorporates by reference for all purposes the full disclosure of co-pending U.S. patent application Ser. No. ______, filed concurrently herewith, entitled “CLASSIFYING, CLUSTERING, AND GROUPING DEMAND SERIES” (Attorney Docket No. 94926-024300US-910874).

### TECHNICAL FIELD

Predictive modeling is a process used in the field of predictive analytics to create a statistical model of future behavior. Demand forecasting models are used to forecast the future sales demand of items as a function of past demand data. One challenge in large scale demand forecasting is to plan a forecasting strategy that minimizes the forecast error. Improving accuracy and efficiency of demand forecasting processes can improve overall sales and operational planning effectiveness. Further, improvements may improve the computational cost and accuracy of a generated forecast model.

### BACKGROUND

Hierarchy information used to generate model forecasts from time series often reflect planning purposes, instead of modeling purposes. Focusing on planning aspects may make it easier to understand and manage the data, but might not be adequate to modeling demand in a time series. For example, a planning hierarchy may group multiple time series having different features together (e.g., a time series with a peak in spring and a time series with a peak in fall). Additionally, or alternatively, a planning hierarchy may group a time series with small variance with another time series having more volatility. In either example, such groupings are not ideal for building a forecasting model due to the time series being directed to different patterns in data.

### SUMMARY

In accordance with the teachings provided herein, systems and methods for improving the accuracy and the efficiency of demand forecasting processes.

For example a computer-program product tangibly embodied in a non-transitory machine-readable storage medium is provided that includes instructions that can cause a data processing apparatus to receive a time series that includes one or more demand characteristics and a demand pattern for an item. The instructions can further cause the data processing apparatus to determine a number of low-demand periods within the time series, a low-demand period being a time interval for which demand for the item is less than a threshold value. The instructions can further cause the data processing apparatus to determine a series type for the time series based on the number of low-demand periods. The instructions can further cause the data processing apparatus to determine an in-season interval of the time series based on the number of low-demand periods and the series type, the in-season interval indicating a demand period for which demand for the Item has historically been greater than the threshold value. The instructions can further cause the data processing apparatus to derive a future in-season interval based on the determined in-season interval, the future in-season interval being a predicted time interval during which demand for the item is predicted to be greater than the threshold value.

In another example, a computer-implemented method is provided that includes receiving a time series that includes one or more demand characteristics and a demand pattern for an item. The method further includes, determining, by a computing device, a number of low-demand periods within the time series, a low-demand period being a time interval for which demand for the item is less than a threshold value. The method further includes determining, by the computing device, a series type for the time series based on the number of low-demand periods. The method further includes determining, by the computing device, an in-season interval of the time series based on the number of low-demand periods and the series type, the in-season interval indicating a demand period for which demand for the item has historically been greater than the threshold value. The method further includes deriving, by the computing device, a future in-season interval based on the determined in-season interval, the future in-season interval being a predicted time interval during which demand for the item is predicted to be greater than the threshold value

In another example, a system is provided that includes a processor and a non-transitory computer readable storage medium containing instructions that, when executed on the processor, cause the processor to perform operations. The operations include receiving a time series that includes one or more demand characteristics and a demand pattern for an item. The operations further include determining a number of low-demand periods within the time series, a low-demand period being a time interval for which demand for the item is less than a threshold value. The operations further include determining a series type for the time series based on the number of low-demand periods. The operations further include determining an in-season interval of the time series based on the number of low-demand periods and the series type, the in-season interval indicating a demand period for which demand for the item has historically been greater than the threshold value. The operations further include deriving a future in-season interval based on the determined in-season interval, the future in-season interval being a predicted time interval during which demand for the item is predicted to be greater than the threshold value.

### BRIEF DESCRIPTION OF THE DRAWINGS

FIG. 1 illustrates a block diagram of an example of a computer-implemented environment for analyzing one or more time series.

FIG. 2 illustrates a block diagram of an example of a processing system of FIG. 1 for classifying, clustering, and grouping, by a demand classification and segmentation (DOS) engine, one or more time series.

FIG. 3 illustrates an example of a block diagram of a process sequence for classifying, clustering, and hierarchical grouping one or more time series.

FIG. 4 illustrates an example of a block diagram of a process for demand classification.

FIG. 5 illustrates an additional example of a block diagram of a process for demand classification.

FIG. 6 illustrates diagram chart with examples of components of a time series.

FIG. 7 illustrates an example of a flow diagram for classifying a time series.

FIG. 8 illustrates an additional example of a flow diagram for classifying a time series.

FIG. 9 illustrates a further example of a flow diagram for classifying a time series.

FIG. 10 illustrates an example of a block diagram for horizontally reclassifying one or more time series.

FIG. 11 illustrates an example of a time series having a demand peak.

FIG. 12 illustrates an example of a segmented time series.

FIG. 13 illustrates an example of a seasonal-type time series.

FIG. 14 illustrates an example of an example of an event-type time series.

FIGS. 15-19 illustrate an example of a process for dynamic volume-grouping of one or more time series.

FIGS. 20-22 illustrate an example of a process for dynamic volume-grouping with hierarchy restriction of one or more time series.

FIG. 23 illustrates an example of a flow diagram for modifying, by a DOS engine, a forecast hierarchy.

FIG. 24 illustrates an example of a flow diagram for generating custom intervals for use in analyzing one or more time series.

Like reference numbers and designations in the various drawings indicate like elements.

### DETAILED DESCRIPTION

Certain aspects of the disclosed subject matter relate to demand classification and segmentation, which may enhance or generate a planning hierarchy so that forecast accuracy can be improved while maintaining ease of data management. Techniques discussed herein can enable users to analyze and classify time series into a set of pre-determined classifications based on certain criteria. “Time series,” as used herein, refers to a sequence of data points, typically consisting of successive measurements made over a time interval. References to “time series” is intended to refer to one or more individual time series unless otherwise specified. For each classification, each time series may be further grouped based on demand patterns and volume characteristics. An aggregation strategy can then be applied to the forecasting process to improve the forecast accuracy.

Demand classification can be accomplished using multiple modules. For example, a demand classification and segmentation engine may include three modules: a classification module, a pattern-clustering module, and a volume-grouping module. A classification module may analyze each time series and classify each time series based on characteristics such as demand lifecycle, intermittence, and seasonality, so that appropriate modeling techniques can be applied to each demand series. A pattern-clustering module may group one or more time series into different clusters based on similar yearly demand patterns as well as the demand characteristics derived from the classification module. Demand at lower levels such as SKU/store demand might often be insufficient to generate accurate forecasts due to low signal to noise ratio. Accordingly, a volume-grouping module may be used to automatically identify an appropriate aggregation level based on a user-defined hierarchy to generate robust and reliable forecasts. The generated forecasts may then be used to reconcile to lower level forecasts.

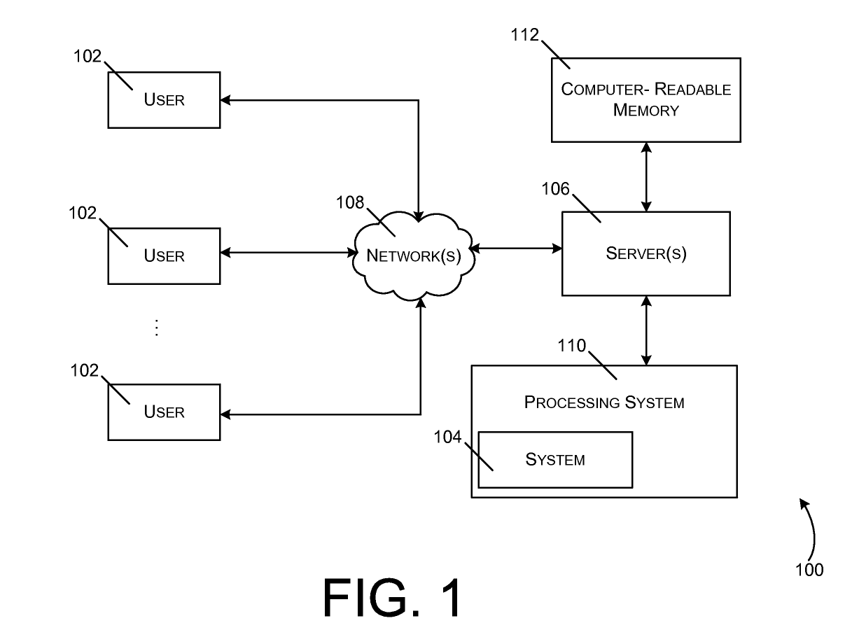

FIG. 1 illustrates a block diagram 100 of an example of a computer-implemented environment for analyzing one or more time series. Users 102 can interact with a system 104 hosted on one or more servers 106 through one or more networks 108. The system 104 can contain software operations or routines. The users 102 can interact with the system 104 through a number of ways, such as over networks 108. Servers 106, accessible through the networks 108, can host system 104. The system 104 can also be provided on a stand-alone computer for access by a user.

In one example, the environment 100 may include a stand-alone computer architecture where a processing system 110 (e.g., one or more computer processors) includes the system 104 being executed on it. The processing system 110 has access to a computer-readable memory 112.

In one example, the environment 100 may include a client-server architecture. Users 102 may utilize a PC to access servers 106 running a system 104 on a processing system 110 via networks 108. The servers 106 may access a computer-readable memory 112.

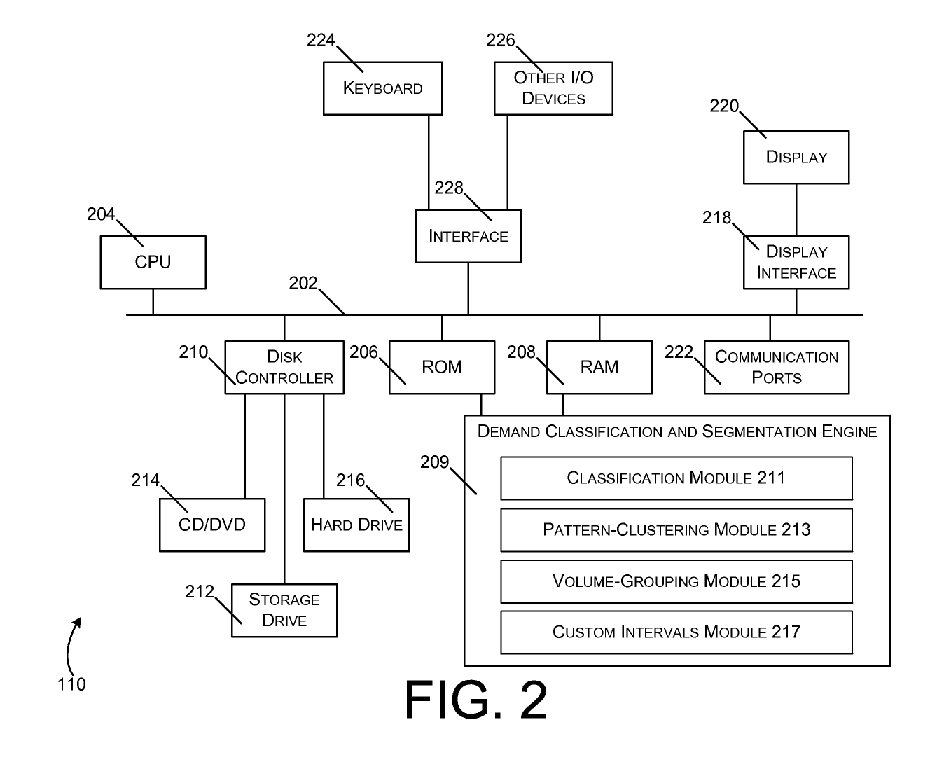

FIG. 2 illustrates a block diagram of an example of a processing system 110 of FIG. 1 for analyzing one or more time series. A bus 202 may interconnect the other illustrated components of processing system 110. Central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing Demand, Classification, and Segmentation engine (DCS engine) 209, as described further in this description, may be stored on storage drive 212, hard drive 216, read only memory (ROM) 206, random access memory (RAM) 208, or may exist as a stand-alone service external to the stand-alone computer architecture. Some or all of the process described in relation to DOS engine 209 may be performed under the control of one or more computer systems configured with specific computer-executable instructions and may be implemented as code (e.g., executable instructions, one or more computer programs or one or more applications) executing collectively on one or more processors, by hardware or combinations thereof. The code may be stored on a non-transitory computer-readable storage medium, for example, in the form of a computer program including a plurality of instructions executable by one or more processors. The computer-readable storage medium may be non-transitory.

DOS engine 209 may include a number of modules (e.g., classification module 211, pattern-clustering module 213, and volume-grouping module 215). These modules may be software modules, hardware modules, or a combination thereof. If the modules are software modules, the modules can be embodied on a computer-readable medium and processed by a processor in any of the computer systems described herein. It should be noted that any module or data store described herein, may be, in some embodiments, a service responsible for managing data of the type required to make corresponding calculations. The modules may exist within the DCS engine 209 or may exist as separate modules or services external to the DCS engine 209. These modules may be directed to performing operations of the DOS engine 209 to accelerate the demand forecasting processes, resulting in improved computational performance of CPU 204 during operations of predictive modeling.

A disk controller 210 can interface one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from bus 202 via interface 228.

### DCS Engine Overview

The DOS engine (e.g., the DCS engine 209) can include at least three modules: a classification module (e.g., classification module 211), a pattern-clustering module (e.g., pattern-clustering module 213), and a volume-grouping module (e.g., volume-grouping module 215).

### Classification Module

The classification module 211 can classify each demand time series based on characteristics such as demand lifecycle, intermittence, and seasonality. A “demand time series,” as used herein, is intended to refer to a time series in which data points represent a degree of demand of an item offered for sale. The classification results (e.g., demand time series statistics) can be output to users to enable the users to apply appropriate modeling techniques to each demand time series.

For example, regular candy and Valentine's day chocolates are usually stored in the same department in a grocery store since they are all candies, but should be put into different segments when modeled because regular candy is a long time-span product that sells all year round. When modeled, it may be possible to study the trend and seasonality of the candy throughout the whole year. In contrast, Valentine's day chocolates are short time-span products that typically sell only around Valentine's day, so when modeled, the user is likely only interested in focusing on a short period of time and is likely only interested in selecting a forecasting technique that is more suitable for time series having a short demand lifecycle. Classifying such items into different segments ensures that suitable factors are considered when modeling the demand for the item.

### Pattern-Clustering Module

The pattern-clustering module (e.g., the pattern-clustering module 213) groups the demand series into different clusters based on similar yearly demand patterns as well as demand characteristics for each demand class derived from the classification module 211. The cluster defines each aggregate series and establishes the forecasting hierarchy so that each aggregated series may be a good representation of its child series.

For example, winter apparels (e.g., jackets) and summer apparels (swimsuits) are both short time-span products, but may have different demand patterns. A combined forecast approach for apparels might result in summer sales forecasts for winter wear items and winter sales forecasts for the swimming gear. Clustering such items separately, however, may ensure that the demand forecasts for the appropriate seasons are considered.

### Volume-Grouping Module

Demand volumes at lower levels in the hierarchy might be insufficient to generate accurate forecasts due to a low signal-to-noise ratio (SNR). In general, volume-grouping enables users to set a threshold level to aggregate sales, establish optimal reconciliation levels, and calibrate forecast models to generate reliable forecasts. The volume-grouping module 215 may reduce noise at lower levels in the hierarchy, so that robust demand signals can be obtained.

### Overall Process Flow

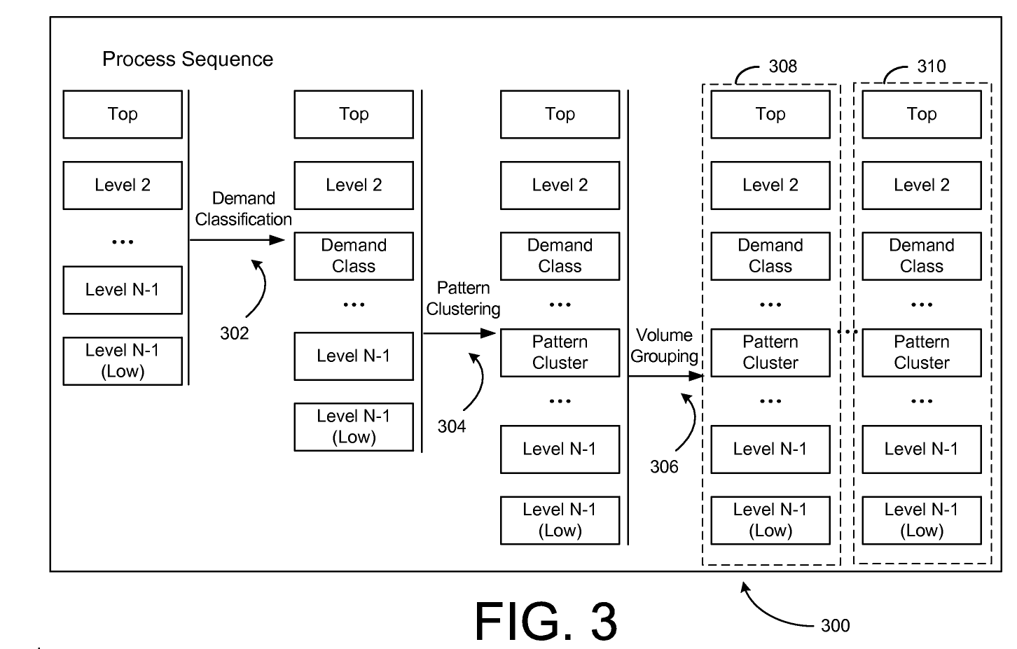

FIG. 3 illustrates an example of a block diagram 300 of a process sequence for classifying, clustering, and hierarchical grouping one or more time series.

At 302, the classification module (e.g., the classification module 211 of the DCS engine 209) may classify each time series at specified level(s) into different classes, generate statistics of each of the demand series, and derive information about the demand characteristics for the time series.

After the demand classes are ascertained for a time series, the pattern-clustering process can be executed for each class of time series at 304. The pattern-clustering module (e.g., the pattern-clustering module 213 of the DCS engine 209) may generate a pattern attribute that is used to cluster the demand series. Demand series with the same, or similar, demand characteristic may be grouped together and clusters may be formed.

Volume group 308 and volume group 310 may be generated at 306 within the scope defined by the classification module 211 and the pattern-clustering module 213. In at least one embodiment, each volume group may be a group of nodes where the volume of an aggregated demand satisfies a minimum threshold. The volume-grouping module groups demand series with the same forecast reconciliation levels.

### Classification Module

The classification module (e.g., the classification module 211 of DCS engine 209) may classify each time series at a specified level or levels into different classes as well as generate demand specific statistics of each time series. The purpose of demand classification is to provide information about each time series that will help in choosing the appropriate forecasting technique.

The classification of a time series may be important because different forecast techniques might be applied to different types of individual time series to improve forecast accuracy. For example, if a time series is known to be an intermittent time series, applying intermittent forecasting techniques (e.g., Croston's method) may produce more accurate forecast than selecting some other time series model (e.g., ARIMA). In addition, among all the intermittent forecasting techniques, some may be better suited to one time series over another. Ascertaining information about the time series by the classification module 211 may enable the classification module 211 to utilize the most suitable technique for forecasting the time series.

### Demand Classification Overview

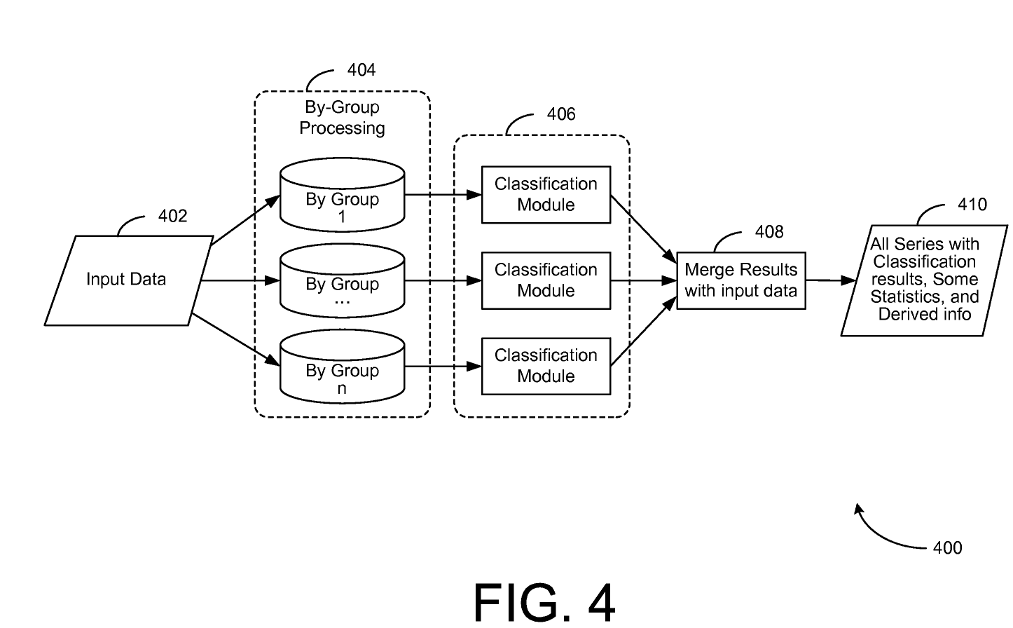

FIG. 4 illustrates an example of a block diagram 400 of a process for demand classification. Classification module 211 can take time series information, hierarchical information, and configuration information as input at 402. At 404, classification module 211 may process the time series using a user-defined class-by-variable. At 406, the classification module 211 can produce outputs for each group including, but not limited to, the classification results, demand specific statistics, and the derived information based on a user's selection. Classification module 211 may merge the outputs with the original input data at 408. At 410, potentially each time series may be assigned preliminary classification results, time series statistics, and derived information related to the time series.

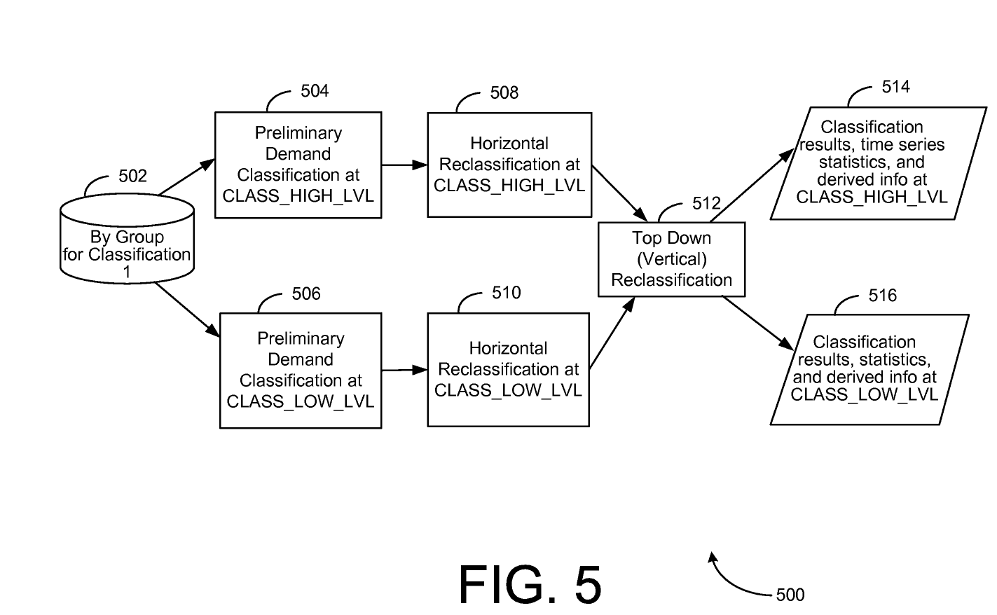

FIG. 5 illustrates an additional example of a block diagram 500 of a process for demand classification. At 502, a classification module 211 may first take input information to conduct a preliminary demand classification at a user-defined CLASS_HIGH level at 504 and a CLASS_LOW level at 506, respectively. The preliminary classification results, statistics, and derived information may be produced for each level at 504 and 506, respectively. Based on each preliminary classification result, horizontal reclassification for time series that cannot be classified due to a lack of history may be performed at each level to generate intermediate classification results at 508 and 510, respectively. With the intermediate classification results at both levels, Top-down (Vertical) Reclassification that combines both the parent and child series characteristics can be optionally performed at 512. In at least one example, top-down (vertical) reclassification may be specified by the user. The classification results may become the final classification results for CLASS_HIGH level and CLASS_LOW level at 514 and 516, respectively.

The demand classification process may have various class types that can be considered. For example, class types may include, but are not limited to, one of a short-history classification (SHORT), a low-volume classification (LOW_VOLUME), a short time-span non-intermittent classification (STS_NON_INTERMIT), a short time-span intermittent classification (STS_INTERMIT), a long time-span seasonal classification (LTS_SEASON), a long time-span non-seasonal classification (LTS_NON_SEASON), a long time-span intermittent classification (LTS_INTERMIT), a long time-span seasonal intermittent classification (LTS_SEASON), an optional long time-span unclassifiable classification (LTS_UNCLASS), an optional unclassified classification (UNCLASS), or an inactive classification (INACTIVE).

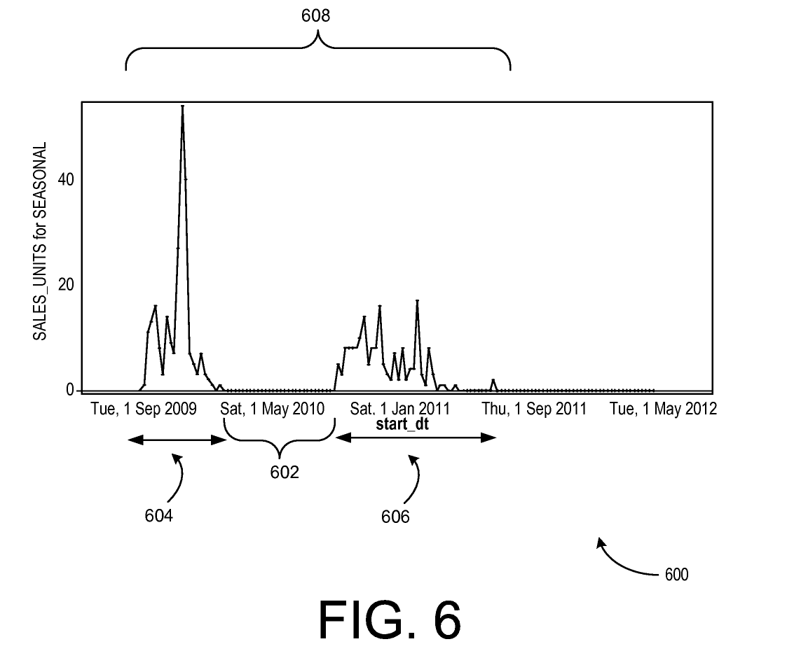

FIG. 6 illustrates diagram chart 600 with examples of components of a time series. Low-demand time period 602 is identified. Low-demand time period 602 is a time period during which demand under some threshold may be considered no demand for the purpose of analysis. Demand cycle 604 and demand cycle 606 each indicate a period for which demand is above the threshold amount. In at least one example, the threshold amount is user-specified (e.g., an absolute value) or determined based on a user specified value (e.g., a specified percentage). A time series 608 may be analyzed to determine whether demand gaps, such as low-demand time period 602, exist within the time series 608. By identifying low-demand time period 602, demand cycle 604 and demand cycle 606 may be identifiable. Based on the length of the demand cycle 604 and demand cycle 606, the time series 608 may be assigned a class type (e.g., “Long Time Span” series or “Short Time Span” series). By analyzing demand cycle 604 and demand cycle 606, characteristics such as seasonality or intermittency may be determined enabling further classification of the time series. Thus, a preliminary classification for the time series may be determined.

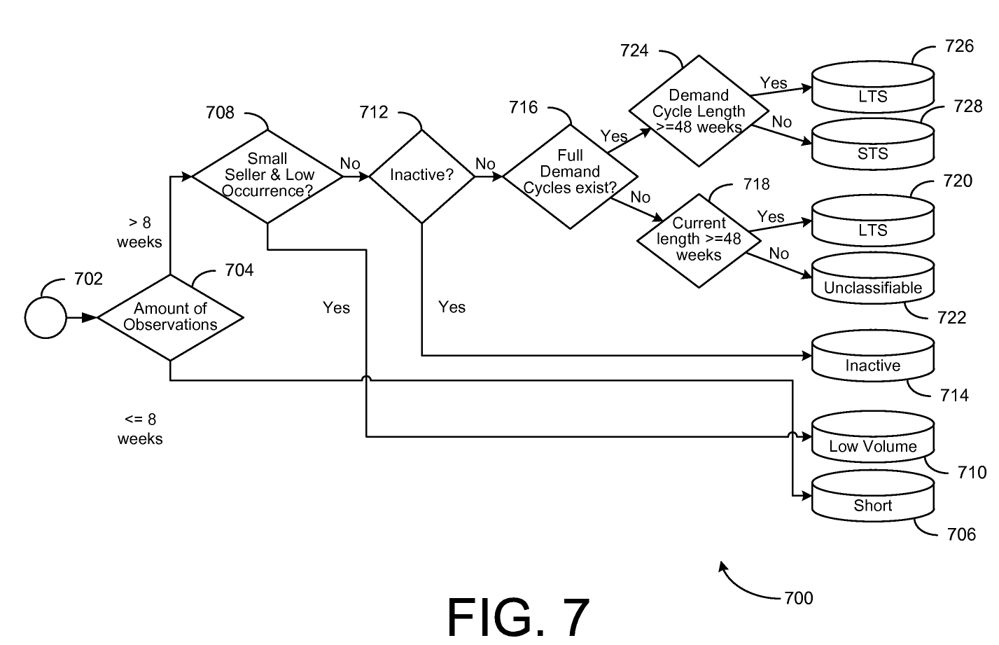

FIGS. 7-9 are illustrations of the classification logic included in the classification module of a DCS engine (e.g., the classification module 211 of the DCS engine 209).

FIG. 7 illustrates an example of a flow diagram 700 for classifying an individual time series. The flow may begin at 702, where an individual time series may be received by, for example, classification module 211. At decision block 704, an amount of observations for the time series may be determined. If the amount of observations is determined to be less than eight weeks, the individual time series may be classified as a short-history classification at block 706. Though this example uses the example of eight weeks, the amount of observations for the time series may be any suitable period of time. If the amount of observations is determined to be greater than eight weeks at block 704, then the flow may proceed to decision block 708.

At decision block 708, classification module 211 may determine whether the seller is small and the occurrence is low as compared to a user-specified threshold value. If the seller is small and there is low occurrence, then the individual time series may be classified as a low-volume classification at block 710. If the seller is not small and there is not a low occurrence, then the flow may continue to decision block 712.

At decision block 712, classification module 211 may determine whether or not the time series is inactive based on a user-specified threshold. If the time series is inactive, then classification module 211 may classify the time series as an inactive classification at block 714. If the time series is not inactive, then the process may continue to decision block 716.

At decision block 716, classification module 211 may determine whether or not the individual time series has full demand cycles. A full demand cycle is a period during which the products are in-season/in-stock and may either be followed by a gap period, or a long inactive period. If the time series does not have full demand cycles, then the flow may proceed to decision block 718. At decision block 718, classification module 211 may determine the length of the current cycle (e.g., by comparing a current time to a latest demand period start). For example, if the latest demand period starts at week 10, and the current time is week 20, then the length of the current cycle is 10. If the length of the current cycle is greater than or equal to 48 weeks, then the classification module 211 may preliminarily classy the time series as a “Long Time-Span” time series at block 720. If the length of the current cycle is less than 48 weeks, then the time series may be classified as “Unclassifiable” at block 722. Though this example uses the example of forty-eight weeks as a threshold value, such a threshold may be any suitable period of time.

If the data set does have full demand cycles at decision block 716, then the process may proceed to decision block 724. At decision block 724, classification module 211 may determine a maximum demand cycle length. A maximum demand cycle length may be determined by computing the length of all full demand cycles followed by selecting the maximum of the computed lengths. If the length of the demand cycle is greater or equal to 48 weeks, or another suitable period of time, then the classification module 211 may classify the time series as a “Long Time-Span” time series at block 726. If the length of the current demand cycle is less than 48 weeks, or another suitable period of time, then the time series may be classified as “Short Time-Span” at block 726.

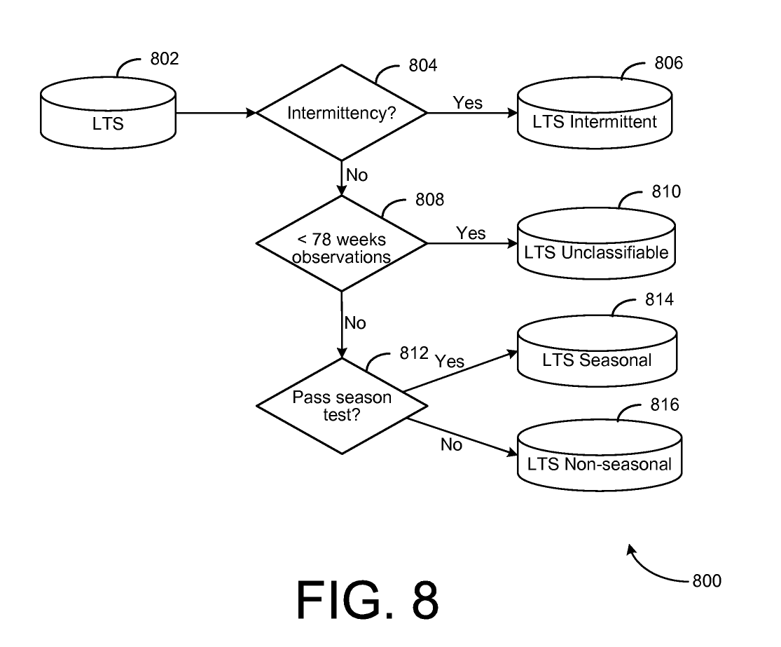

FIG. 8 illustrates an example of a flow diagram 800 for classifying a Long Time-Span (LTS) time series. The flow may begin at 802, where a time series having a “Long Time-Span” classification may be obtained, for example, by classification module 211. At decision block 804, classification module 211 may determine whether or not the LTS time series is intermittent. Intermittency may be determined based on all non-gap periods and a user-specified threshold. If the LTS series is intermittent, classification module 211 may classify the time series as a “Long Time-Span Intermittent” time series at block 806. If the LTS series is not intermittent, then the flow may proceed to decision block 808.

At decision block 808, classification module 211 may determine a length of time over which observations are included in the time series. If the number of observations spans less than, for example, 78 weeks, then classification module 211 may preliminarily classify the time series as a “Long Time-Span Unclassified” time series at block 810. If the number of observations spans less than at least, for example, 78 weeks or more, then the flow may proceed to decision block 812. Though 78 weeks is given as an example, it should be noted that any suitable period of time may be similarly utilized.

At decision block 812, classification module 211 may determine whether or not the time series passes a season test (e.g., SAS standard season test). If the time series passes the season test, then the time series may be classified as a “Long Time-Span Seasonal” time series at block 814. If the time series does not pass the season test, then classification module 211 may classy the time series as a “Long Time-Span Non-Seasonal” time series at block 816.

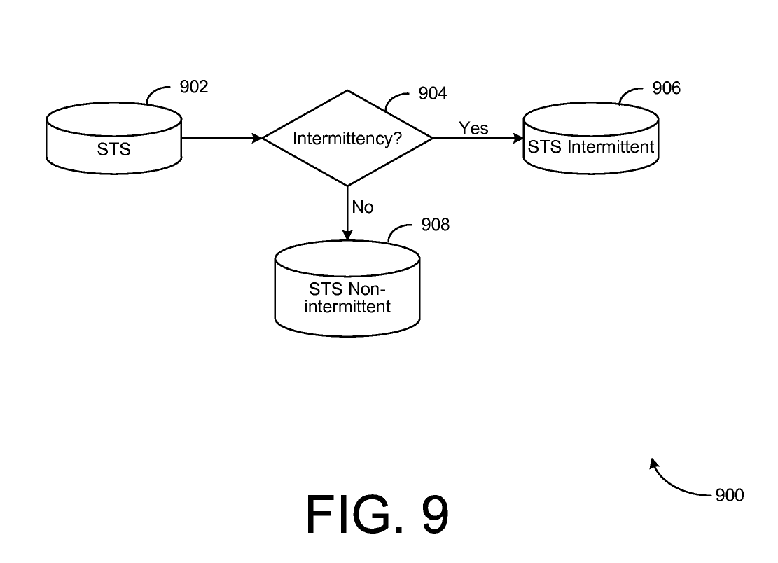

FIG. 9 illustrates an example of a flow diagram 900 for classifying a “Short Time-Span” (STS) time series. The flow may begin at 902, where a data set having a “Short Time-Span” classification may be obtained by classification module 211. At decision block 904, classification module 211 may determine whether or not the STS time series is intermittent. As stated above, intermittency may be determined based on all non-gap periods and a user-specified threshold. If classification module 211 determine that the STS time series is intermittent, then the data set may be classified as a “Short Time-Span Intermittent” time series at block 906. If classification module 211 determines that the LTS time series is not intermittent, then the time series may be classified as a “Short Time-Span Non-Intermittent” time series at block 908.

### Horizontal Reclassification

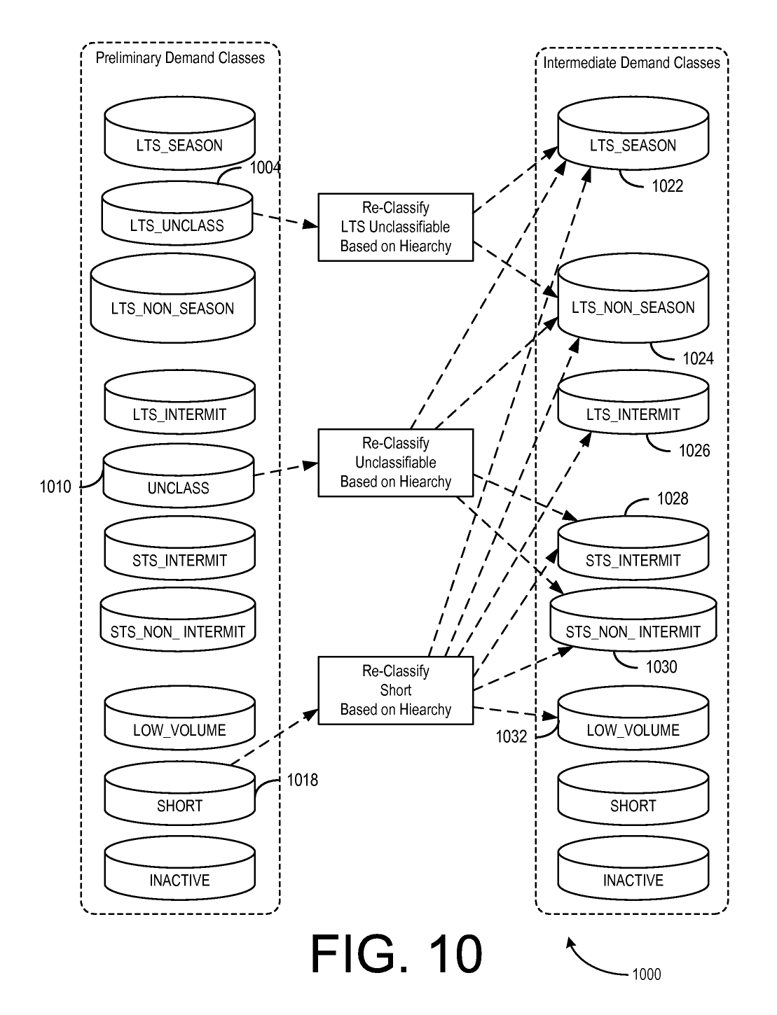

FIG. 10 illustrates an example block diagram 1000 for horizontally reclassifying a time series. Some time series may be difficult to classify due to lack of history, for example, it may be impossible to determine if a “long time-span” time series is seasonal or non-seasonal based on only 56 weeks of data. In this case, classification module 211 may classify the time series as an “Unclassifiable” series and then re-classify the time series by analyzing information from the time series' sibling time series in the hierarchy.

As shown in FIG. 10, LTS_UNCLASS classification 1004, UNCLASS classification 1010 and SHORT classification 1018 can be optionally reclassified using horizontal reclassification. LTS_UNCLASS classification 1004 can be optionally reclassified as either LTS_SEASON classification 1022 or LTS_NON_SEASON classification 1024. UNCLASS classification 1010 can be reclassified as one type among LTS_SEASON classification 1022, LTS_NON_SEASON classification 1024, LTS_INTERMIT classification 1026, STS_INTERMIT classification 1028, and STS_NON_INTERMIT classification 1030. SHORT classification 1018 can be reclassified as one type among LTS_SEASON classification 1022, LTS_NON_SEASON classification 1024, LTS_INTERMIT classification 1026, STS_INTERMIT classification 1028, STS_NON_INTERMIT classification 1030, or LOW_VOLUME classification 1032.

### Top-Down Reclassification

For “Long Time-Span” time series with a characteristic of intermittency, it may be difficult to whether or not the time series is seasonal because of the sparseness of the observations. This is where Top-down Reclassification may be utilized. The seasonality information from the hierarchy can be used, but instead of analyzing sibling series, which could all be intermittent, the usually less-sparse parent series may be analyzed. If the parent series is seasonal, then the child series may also be considered to be seasonal.

To be more specific, the reclassification may be done solely at CLASS_LOW level based on the intermediate classification results for both the CLASS_LOW and CLASS_HIGH level. If the parent series at the CLASS_HIGH level has been classified as LTS_SEASON, and the child series at the CLASS_LOW level has been classified as LTS_INTERMIT, then the Top-down Reclassification may reclassify the CLASS_LOW level child series as LTS_SEASON INTERMIT.

### Pattern-Clustering Module

The pattern-clustering module (e.g., the pattern-clustering module 213 of DCS engine 209) may group demand series based on demand patterns such as year-over-year monthly demand proportions, a monthly demand average, or parameter estimates based on ARIMA models. Pattern groups can be used in budding a forecast hierarchy and improve forecast accuracy.

For example, winter clothes and summer swimming suits can both be short time-span products, but these products may have different demand patterns. Forecasting these products together may lead to inaccuracies due to the differing demand patterns. Forecasting the products separately, however, can ensure that the correct seasonality is considered.

In at least one example, demand series with similar patterns may be clustered together for each “long time-span seasonal” and “short time-span” time series. Various techniques can be used for clustering. For example, hierarchical clustering, K-means clustering, or a combination of the two may be used to cluster demand series with other time series having the same, or similar, demand patterns.

Hierarchical clustering can automatically determine an optimal number of clusters. However, hierarchical clustering may produce performance issues especially when the number of items to cluster exceeds a certain limit. K-means methods are computationally efficient. However, K-means methods may involve having to pre-specify a number of clusters. Thus, a hybrid process may be considered that combines the two methods to make use of the advantages of each method.

In at least one example, pattern-clustering module 213 may utilize a k-means algorithm to generate an initial set of clusters. A hierarchical clustering algorithm may be used on the cluster centers generated from the k-means algorithm to determine an optimal number of clusters. Pattern clustering module 213 may execute the k-means algorithm with the original data as input, using the optimal number of clusters as determined by the hierarchical clustering algorithm.

The pattern-clustering module 213 can separate short time-span products with different selling seasons. Additionally, the pattern-clustering module 213 may identify key features to be considered in the model.

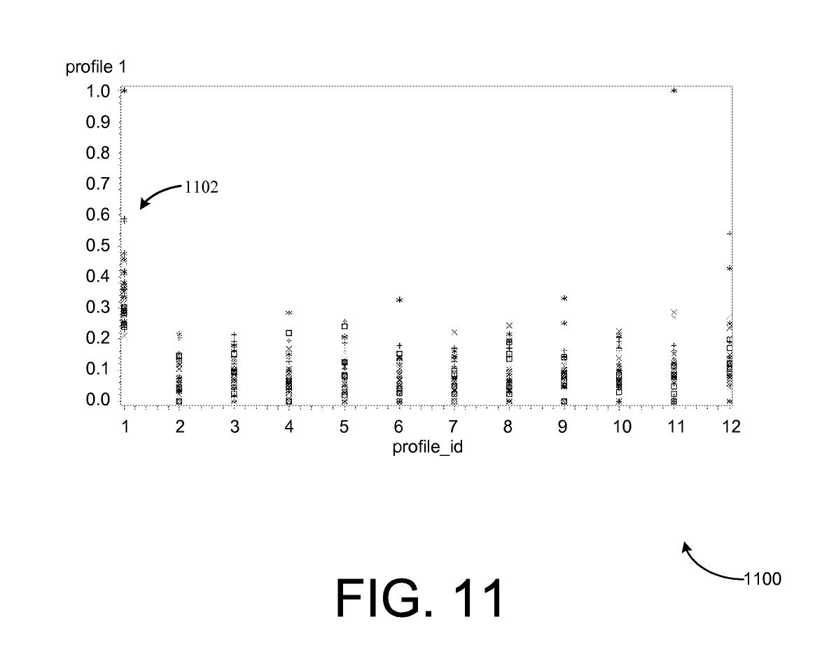

For example, if pattern-clustering results in 14 clusters, among all clusters, 12 clusters reveal demand peaks in 12 different months, from January to December. FIG. 11 illustrates a demand series having a demand peak 1102 which occurs, for example, in January. Though the month of January is utilized in FIG. 11, any month of the year, or any suitable period may be utilized. A demand peak illustrates when an item may be most in demand, or, in other words the demand peak illustrates when the most sales of the item have occurred.

### Custom Intervals

Traditional forecasting algorithm uses standard calendar/standard time intervals that often do not work well with highly seasonal time series data having many inactive periods. For example, an Easter toy may only sell during a particular time of year, where the precise dates may shift, making predictions difficult to ascertain. Techniques that require a user to define an interval for the event (e.g., the weeks before and after the Easter holiday for which the toy will be in demand) are cumbersome and may produce inaccurate forecasts. Identifying a custom interval of the event or a season (e.g., winter) within the time series from the time series data can produce more accurate forecasts. Additionally, predicting future event intervals or season intervals based on custom intervals can be more efficient and more accurate than requiring user-defined intervals.

Custom intervals may be determined by a separate custom intervals module 217, or by any of the modules discussed herein. A module responsible for determining custom intervals for the demand in a time series may be part of a DOS engine (e.g., the DCS engine 209) or a component separate from the DOS engine.

Custom intervals module 217, or alternatively, classification module 211, may identify demand gaps in the time series. Demand classification, discussed above, can be used to identify demand gaps. For example, consecutive low demands with a length exceeding some threshold (e.g., 1 week) may be identified as a demand gap. The identified demand gaps may be used to determine demand cycles (e.g., periods for which demand is over a threshold amount for a threshold period of time). Once demand cycles are determined, the time series may be classified (e.g., by custom intervals module 217 or classification module 211) as one of the classifications discussed above.

Custom intervals module 217, or alternatively, pattern-clustering module 213, may duster time series having the same, or similar, demand classifications together. Through clustering similar products with the same, or similar, seasonal pattern together, a stronger seasonal signal may be obtained. A stronger seasonal signal can result in more accurate custom intervals. Any suitable aggregation technique may be utilized, for example, the pattern-clustering algorithm discussed above in connection with the pattern-clustering module 213.

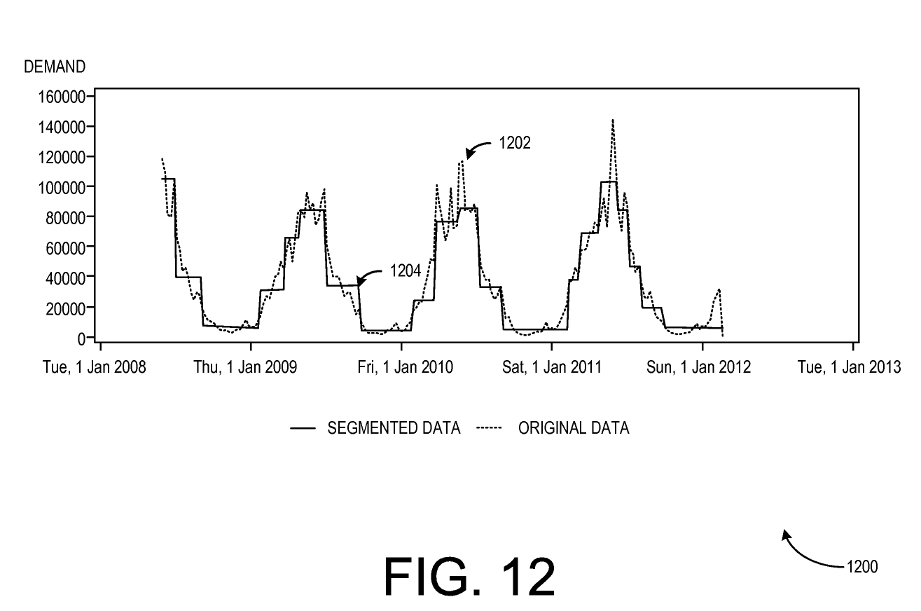

A process utilized by custom intervals module 217 for determining custom intervals may first begin with identifying demand gaps of the time series, or alternatively, of the aggregated time series. Demand classification, as discussed herein, may be utilized to identify such demand gaps. Alternatively, a time series segmentation or representation algorithm may be used to first approximate the time series. A time series can be represented as a sequence of individual segments, each with its own characteristic properties. A time series segmentation algorithm may be utilized by custom intervals module 217 to split the time-series into a sequence of such segments. FIG. 12 illustrates an example of a segmented time series, where dotted line 1202 illustrates the original time series data and solid line 1204 illustrates the segments of the time series. “Segments,” as used herein, is intended to refer to an approximation of the original time series data over a given period of time. Demand gaps, and corresponding demand cycles, may then be determined from the segments of the time series in a similar manner as described above.

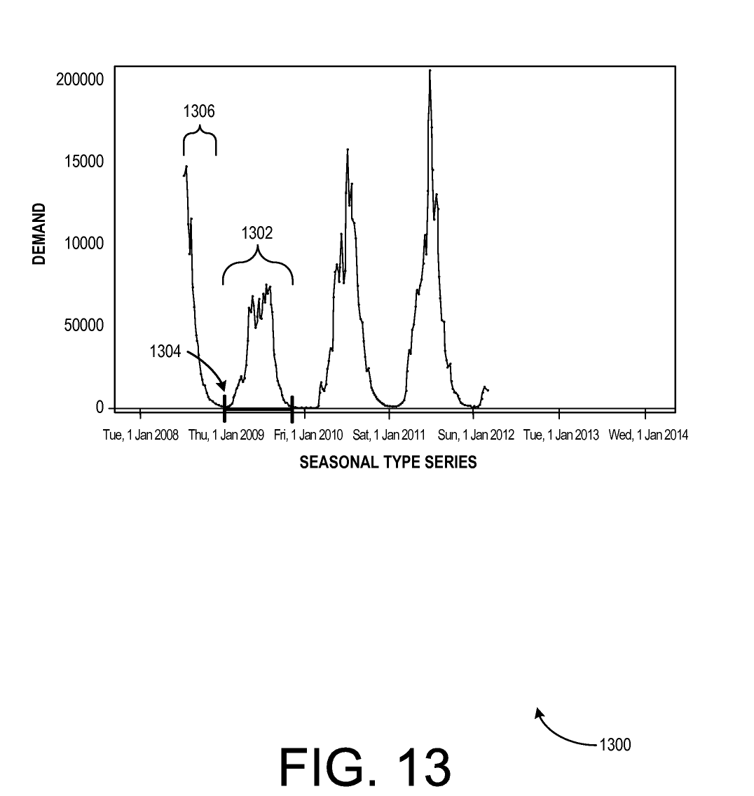

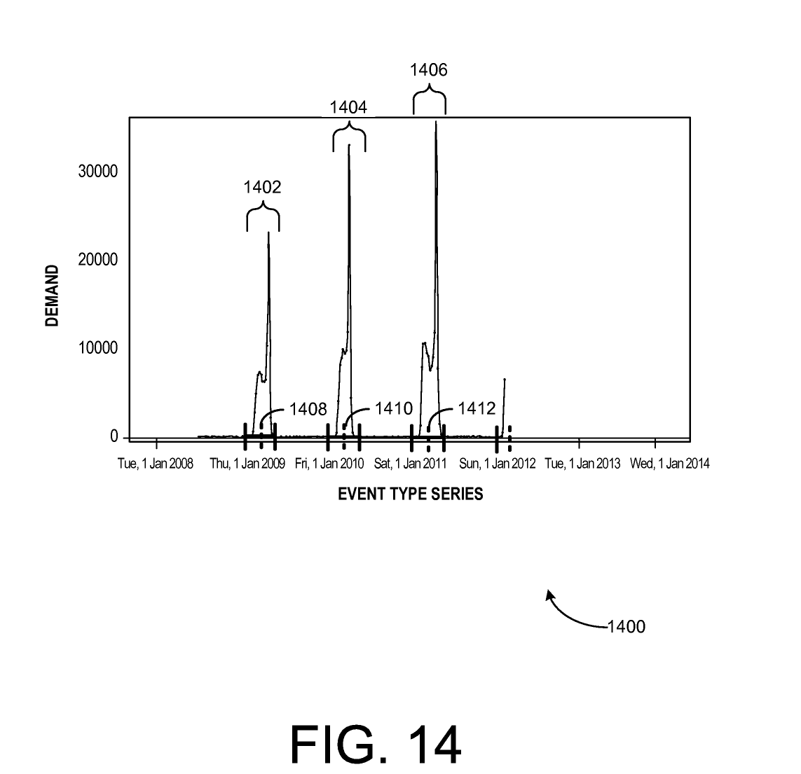

In at least one embodiment, the identified demand cycles may be classified as “event” or “seasonal” (e.g., by custom intervals module 217 or classification module 211) For example, if the mean demand cycle is larger than a seasonal threshold (e.g., 4 weeks) than the time series may be classified as “seasonal.” Alternatively, if an event (e.g., a holiday) occurs during the demand cycle, then the time series may be classified as “event.” FIG. 13 illustrates an example of a seasonal type time series. Demand cycle 1302 is indicative of a season-type time series because the demand cycle 1302 is greater than a threshold length. Data point 1304 may indicate the start of the season-type time series because the demand at data point 1304 is substantially zero, with a period of increasing demand occurring immediately thereafter. Demand cycle portion 1306 may indicate a portion of a previous demand cycle (previous with respect to demand cycle 1302), because demand cycle portion 1306 begins with a non-zero value. A seasonal threshold length may be pre-defined and may be defined as any length of time. FIG. 14 illustrates an example of an event-type time series. Demand cycles 1402, 1404, and 1406 are indicative of an event type time series because the demand cycles 1402, 1404, and 1406 are less than a threshold length. Additionally, event 1408 occurs during demand cycle 1404, further indicating an event type time series. Similarly event 1410 and event 1412 occur during demand cycles 1404 and 1406, respectively, further indicating an event type time series. Though the demand in FIG. 14 appear to be substantially the same length, it should be noted that the demand cycles may be the same, similar, or different lengths, each of which are less than a threshold length.

In one example, custom intervals module 217 may modify the demand cycle periods so that each demand cycle length is substantially the same. For example, demand cycles 1402, 1404, and 1406, may be analyzed to calculate a custom interval. Various methods determining a custom interval may be employed. For example, a user may select an interval rule that governs the manner in which the custom interval may be determined. Example interval rules may include, but are not limited to, a minimum interval rule, a maximum interval rule, a mean interval rule, and a mode interval rule. Applying a minimum rule may result in a custom interval length that is less than a custom interval length determined by application of a maximum rule. For example, over the course of several years, an event type time series may indicate that each time an event occurs, the demand cycle for such events are, for example, at least three weeks long, and, for example, at most six weeks long. In this case, applying a minimum interval rule may result in future event intervals being customized to three weeks long, while applying a maximum rule may result in future event intervals being customized to six weeks long. Similarly, a mean rule and a mode rule may analyze event occurrences in the event type time series and determine a custom interval length based on the mean length of event cycles in the time series, or a mode length of event cycles in the time series, respectively. In some embodiments, the interval rule used to calculate the custom interval length may be pre-specified.

Custom intervals module 217 may also apply Interval rules in a similar manner to seasonal-type time series to determine a season length. For example, a time series may indicate that a season typically starts on the week ten of a year and lasts at least sixteen weeks and at most twenty weeks. Application of a minimum interval rule may result in a custom interval for the seasonal type time series of sixteen weeks. Application of a maximum interval rule may result in a custom interval for the seasonal type time series of twenty weeks. The mean interval length over the course of the seasonal time series may be twelve weeks. Application of the mean interval rule may result in a custom interval for the seasonal-type time series of twelve weeks. The length of season occurring most often (e.g., a mode interval length) in the seasonal-type time series may be, for example, thirteen weeks. Thus, application of the mode interval rule may result in a custom interval for the seasonal-type time series of thirteen weeks.

In some cases, a time series may include an incomplete demand cycle. For example, Demand cycle portion 1306 of FIG. 13 illustrates a demand cycle that is incomplete. Demand cycles that are incomplete do not start with leading demands higher than a particular threshold (e.g., zero). In some cases, custom intervals module 217 may exclude incomplete demand cycles from custom interval analysis since the inclusion of these cycles may skew custom interval calculations.

Determined custom intervals may be used to predict a future event or season. For example, having determined a custom interval of three weeks for an event (e.g., Easter, Apr. 20, 2014), a future demand cycle for a similar future event may be calculated based on identifying the day on which the event occurs in the future (e.g., Easter, Apr. 5, 2015). Similarly, having determined a custom interval of sixteen weeks for a season (e.g., summer 2014) and a start index for the season (e.g., typically week 26), future demand cycles for the season may be predicted.

### Volume-Grouping Module

### Volume-Grouping Overview

Demand forecasting for lower levels in the hierarchy might result in poor statistical forecasts due to insufficient demand volume and large random variations. Reliable forecasts can be generated if there is a sufficient volume of data. Volume-grouping can be used to aggregate data and minimize random variation in data. By aggregating data, stronger underlying demand signals can be obtained. This may make demand patterns easier to be detected by the models.

The volume-grouping module (e.g., the volume grouping module 215) enables users to determine the appropriate forecast reconciliation level to ensure that the forecasts are generated at a level with sufficient demand volume while retaining, as much as possible, specific patterns of each demand time series.

Volume-grouping module 215 may generate a number of volume groups. These volume groups may be generated based on the user-specified volume threshold, which can be based on the demand averages. A user can define a level in the hierarchy as the lowest grouping level. Starting from the lowest grouping level, if a series has sufficient volume, then a forecast may be generated at the lowest level to capture any series-specific patterns. Otherwise, the series may be aggregated to one level higher via the input hierarchy with other low volume series until it reaches a level with sufficient volume, or alternatively, it reaches the top level.

The process of volume-grouping can be run staid-alone, or after classification and pattern-clustering. Volume-grouping module 215 may generate forecasts at a volume-group level and disaggregate data down to lowest level. Two hierarchy-based volume-grouping types utilized by volume-grouping module 215 include dynamic grouping and dynamic grouping with hierarchy restriction.

### Dynamic Grouping

In a dynamic grouping type there can be two parameters defined as the volume threshold. For example, avg_demand_threshold and min_frequency_threshold. If the average demand of an aggregated time series is greater than, or equal to the avg_demand_threshold, and the number of demand occurrences is greater than, or equal to, the min_frequency_threshold, then the time series may be considered to have sufficient volume.

If a series at the lower level has sufficient volume, then the forecast may be generated at this particular level to capture any series-specific patterns. Otherwise, the time series may be aggregated to one level higher with other low volume series until an aggregated time series reaches a level with sufficient volume, or the aggregated time series reaches the top level. Some further details are illustrated through the following example.

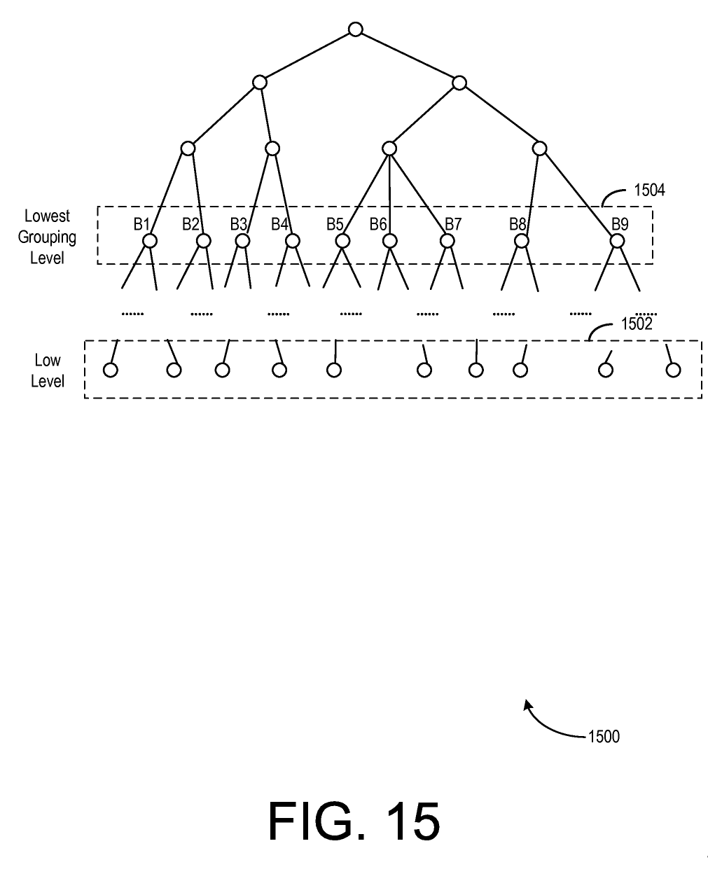

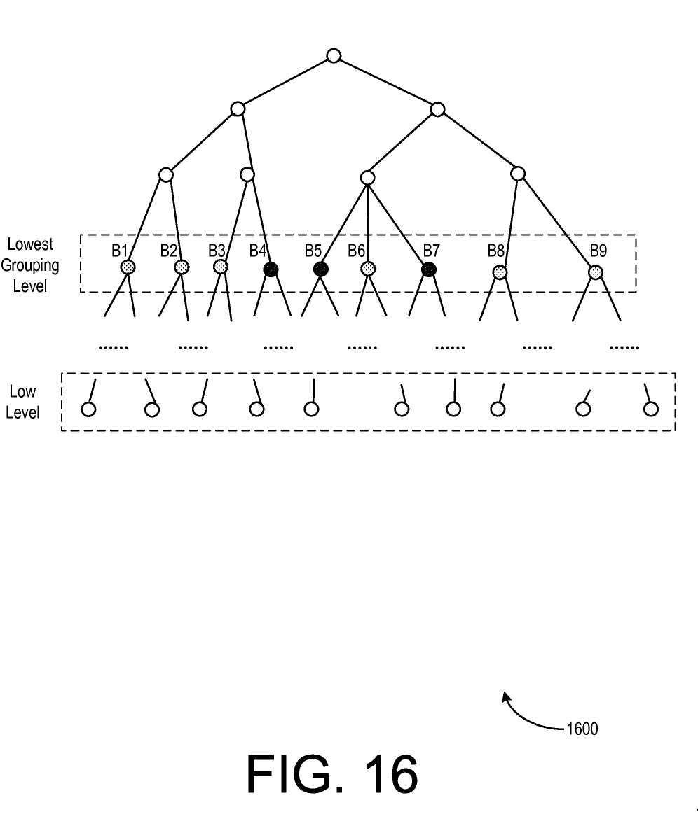

FIGS. 15-19 illustrate an example process for dynamic volume-grouping utilizing a volume-grouping module (e.g., the volume-grouping module 215). FIG. 15 illustrates an example hierarchy prior to volume-grouping by the volume-grouping module 215. As a first operation, the volume-grouping module 215 may aggregate all series up from low level 1502 to a lowest grouping level 1504. At FIG. 16, the volume-grouping module 215 may compare a demand volume (average demand and demand occurrences) of each node of the hierarchy with one or more threshold values to determine if the node (e.g., the time series) has sufficient volume. Black nodes (e.g., nodes B4, B5, and B7) indicate nodes that have sufficient volume (e.g., the volume at such node is greater than a threshold volume). Dotted nodes (e.g., nodes B1, B2, B3, B6, B8, and B9) indicate low volume nodes, which do not have sufficient volume (e.g., a volume that is less than the threshold volume.

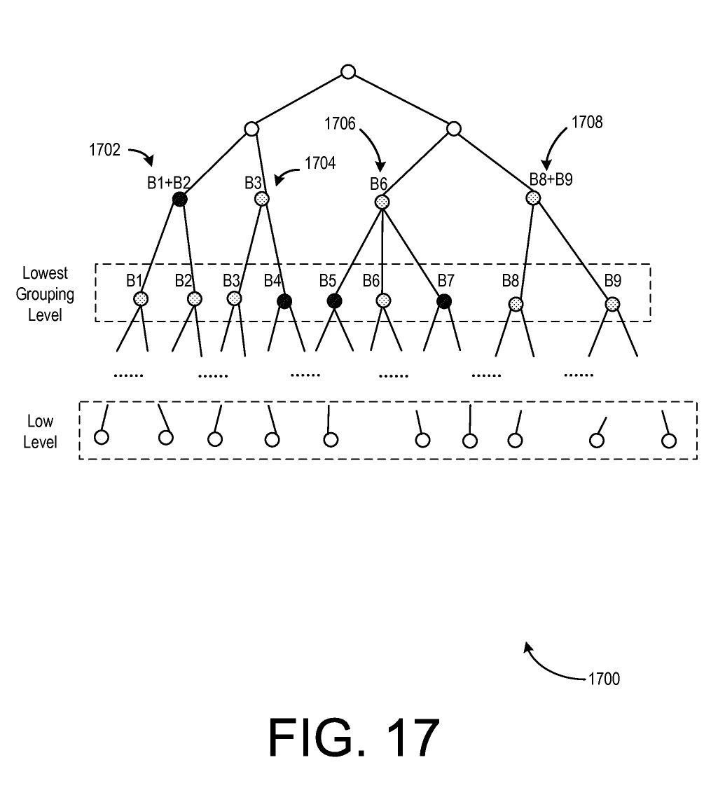

In FIG. 17, the volume-grouping module 215 may aggregate all nodes with insufficient volume up one level in the hierarchy. In this example, volume grouping module 215 aggregates node B1 with node 32 depicted with node B1+B2 at 1702. Nodes B3 and B6 may be determined by volume-grouping module 215 to have sufficient volume, and thus those nodes may be moved up a level as depicted at 1704 and 1706, respectively. Additionally, volume group module 215 may aggregate node 38 with node B9 to node B8+B9 at 1708. FIG. 17 shows the status of each node at the corresponding level: node B1+B2 has sufficient volume, while all the rest of the nodes still need to be aggregated further.

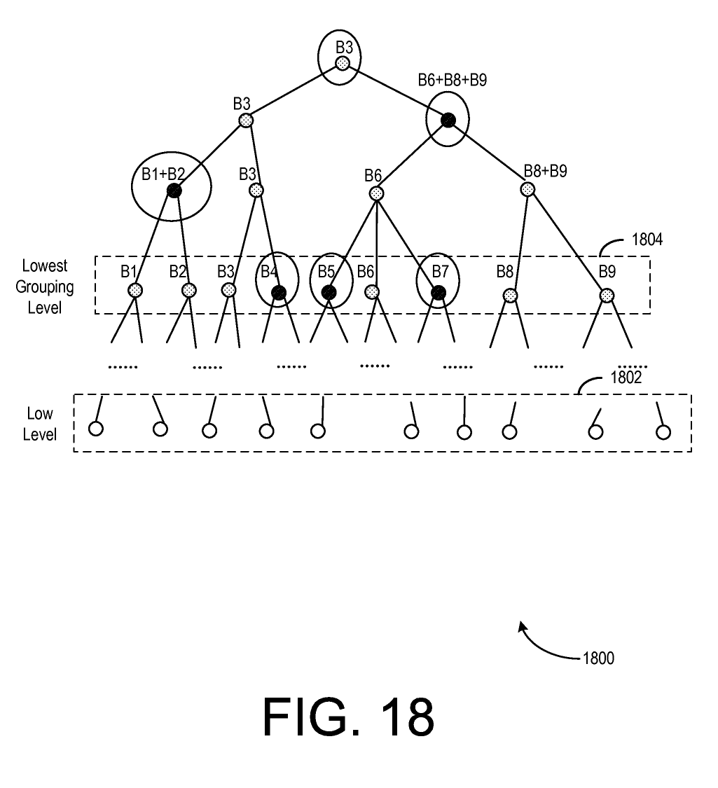

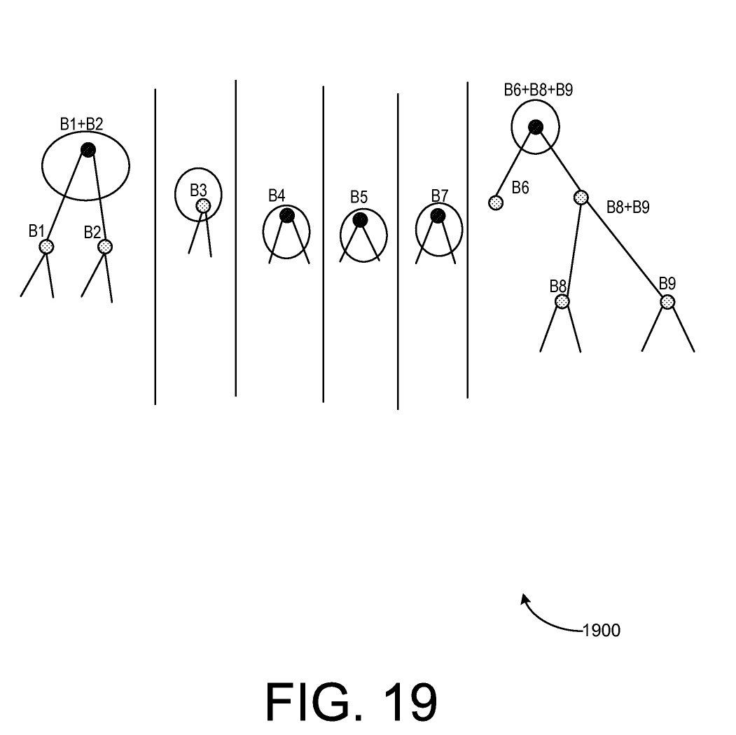

Volume-grouping module 215 may repeat the process described above until each branch has a top-most node that exceeds the volume thresholds, or until the top of the hierarchy is reached. FIG. 18 depicts an example volume grouping in which black nodes depict nodes with sufficient volume. FIG. 19 illustrates an example set of final results using the dynamic grouping method of volume-grouping module 215, with a result of six groups and three reconciliation levels. Five of the volume groups satisfy the volume threshold. B3 ends up as a low volume cluster since it reaches the top level.

Dynamic Grouping with Hierarchy Restriction

In the example shown in FIGS. 15-19, node 33 may be a volume group, even though node 33 does not have sufficient demand. This outcome might not satisfy customer needs, since a customer may require that all groups have sufficient demand in order to generate a forecast. For example, restrictions may be added when conducting the dynamic grouping. If a series at a lower level has sufficient volume, or if any of its siblings do not have sufficient volume, all nodes with a common parent may be aggregated (e.g., by volume-grouping module 215) to keep the original hierarchy. Volume-grouping module 215 may assign a group to the node if all sibling nodes of the node have sufficient volume.

As used herein, “qualified nodes” are nodes that pass the volume threshold, while “unqualified nodes” are nodes that do not pass the volume threshold. In at least one example, if the number of unqualified nodes exceed a certain percentage of the total number of siblings (min_unqualified_node_count_pct), or the total demand of the unqualified nodes is greater than a certain percentage of the total demand of all siblings (min_unqualified_volume_pct), then the sibling nodes may be aggregated up and continue the process. Otherwise, all siblings may be assigned a group and the current level may be selected as the level to reconcile. In one example, the same hierarchy may be used from FIG. 15. As depicted in FIG. 16, nodes 34, 35 and B7 are qualified nodes, but not all of them have unqualified siblings. Therefore, nodes B4, B5, and B7 need to be aggregated to the next highest level.

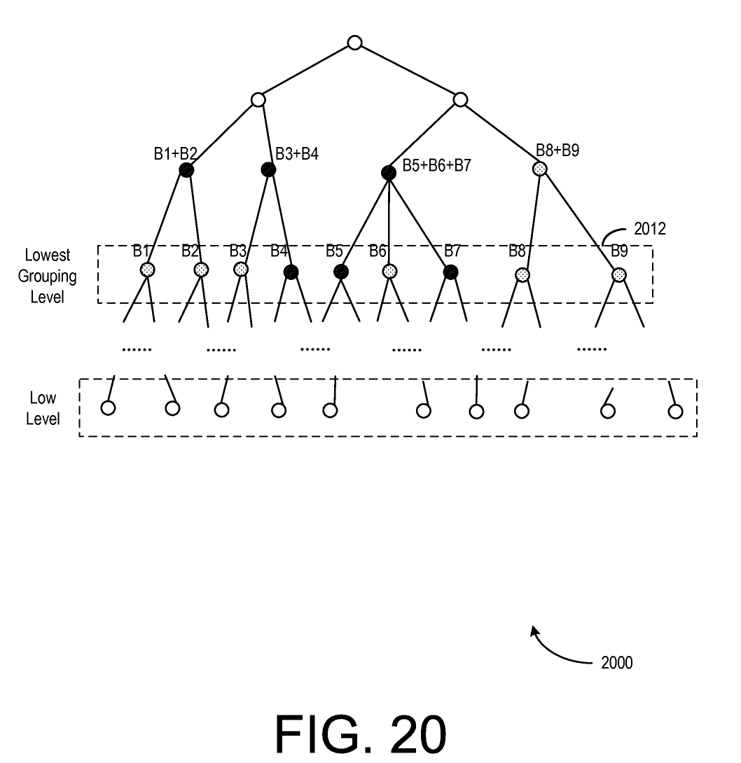

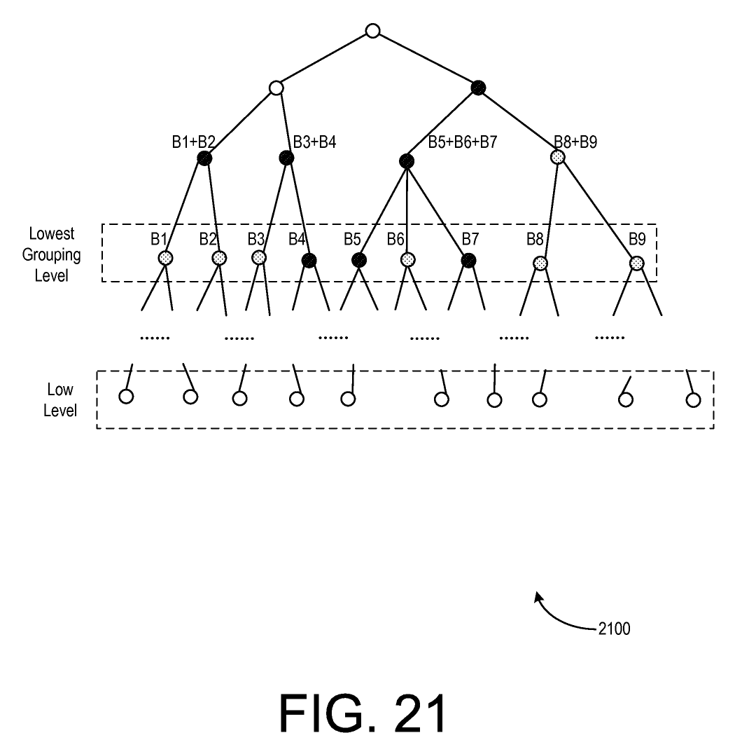

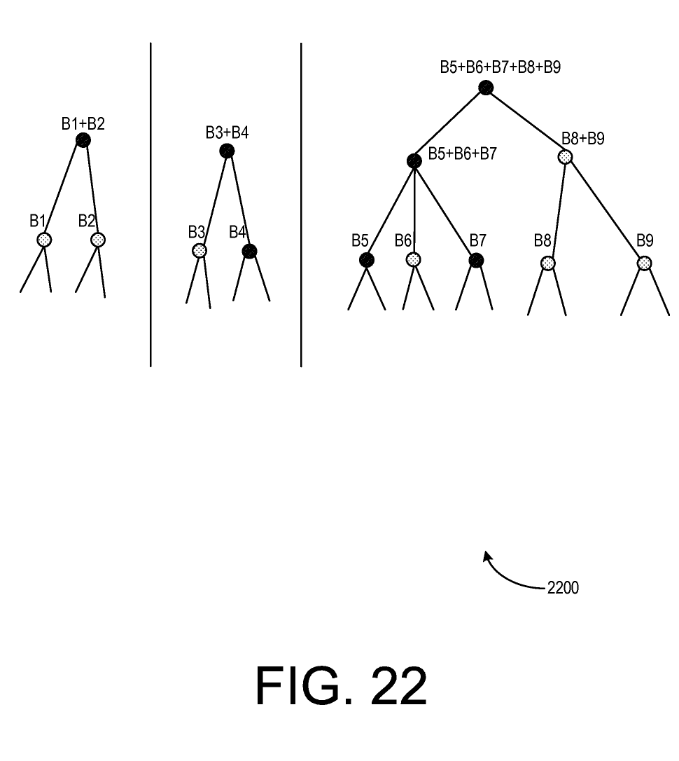

As depicted in FIG. 20, node B5+B6+B7 is a qualified node, however, its sibling B8+B9 is still unqualified. Therefore, it still needs to aggregated to a higher level, until all siblings are qualified nodes as depicted in FIG. 21. FIG. 22 illustrates the resulting aggregation with three volume groups and two reconciliation levels.

### Process Example

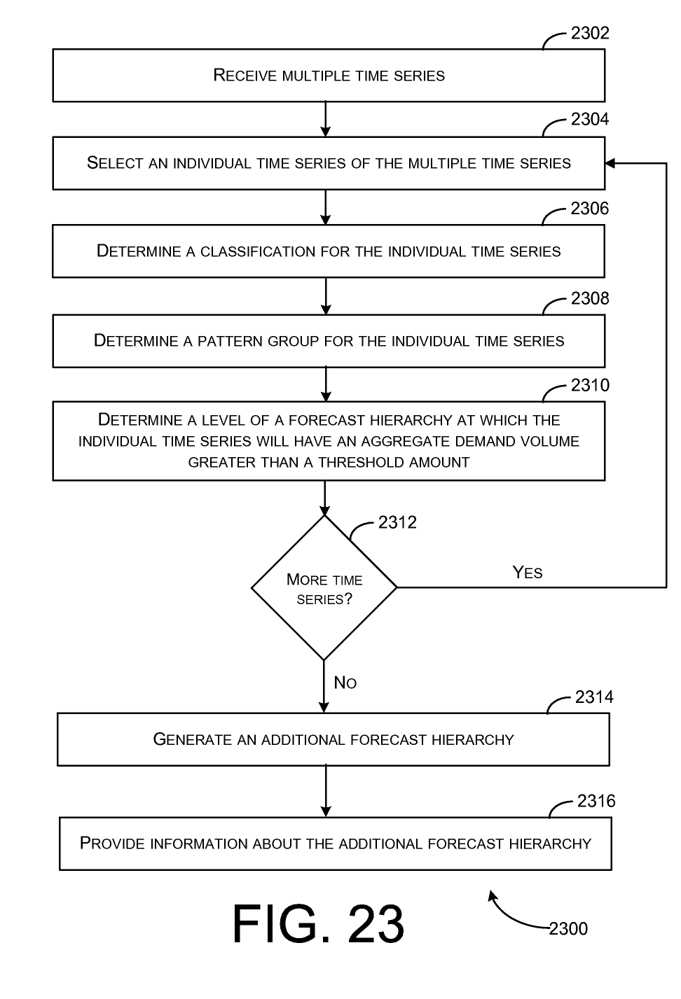

FIG. 23 illustrates an example of a flow diagram 2300 for modifying, by a DCS engine (e.g., the DCS engine 209 of FIG. 2), a forecast hierarchy. The flow 2300 may begin at block 2302, where multiple time series are received (e.g., by DCS engine 209 of FIG. 2). For example, the multiple time series may be included in a forecast hierarchy (e.g., the forecast hierarchy of FIG. 15, where each node of the forecast hierarchy represents a time series). The forecast hierarchy may depict relationships between time series, for example, parent-child relationships. In at least one example, a parent time series may relate to a broader category of items than an item for which a child time series may relate. A parent time series may include sales information, for example, of candy sold in a supermarket. A child time series of the parent time series may include sales information, for example, of chocolate candy sold in the supermarket. Another child time series of the parent time series may include sales information of Christmas candy sold in the supermarket. Each time series may include one or ore demand characteristics and one or more demand patterns for an item.

At block 2304, an individual time series of the multiple time series may be selected. For example, the forecast hierarchy may be traversed to select a time series. Alternatively, time series may be selected at random.

At block 2306, a classification for the individual time series may be determined. The classification may be determined (e.g., by classification module 211 of FIG. 2) in a manner similar to that described above with respect to demand classification. For example, demand gaps may be identified in order to determine demand cycles of the time series. Depending on the length and frequency of the demand cycles, a classification may be determined for the time series.

At block 2308, a pattern group for the individual time series may be determined (e.g., by pattern-clustering module 213 of FIG. 2). The pattern group may be determined in a manner similar to that described above with respect to pattern-clustering. For example, time series having demand cycles during a same, or similar, time of year may be clustered together using k-means and hierarchical clustering algorithms. Time series belonging to the same duster may be assigned a common pattern group.

At block 2310, a level of the forecast hierarchy at which the individual time series will have an aggregate demand volume greater than a threshold amount may be determined (e.g., by volume-grouping module 215 of FIG. 2). An aggregate demand volume for the individual time series may be determined through dynamic grouping or dynamic grouping with hierarchy restrictions as described above.

At block 2312, a determination as to whether or not more time series are in the forecast hierarchy is made. If more time series exist, then the flow may proceed back to block 2304 and block 2304 to block 2312 may be repeated until no more time series exist in the hierarchy that have not been classified, grouped, and aggregated according to block 2306 through block 2310.

When no more time series exist in the forecast hierarchy, the flow may proceed to block 2314 where a second forecast hierarchy may be generated (e.g., by DCS engine 209 of FIG. 2). Though the flow depicts generating the second forecast hierarchy as a final step, it should be understood that the second forecast hierarchy may alternatively be incrementally generated at any point between block 2302 and block 2310. In at least one example, generation of the second forecast hierarchy may include associating classification data, pattern group data, or aggregation data to a node of the first forecast hierarchy. Alternatively, generation of the second forecast hierarchy may include modifying metadata related to each node, or time series, included in the first forecast hierarchy. Further, a second forecast hierarchy, separate from the first forecast hierarchy may be generated, the second forecast hierarchy having a different arrangement of nodes based on at least one of the classification data, the pattern group data, or the aggregation data associated with each time series included in the second forecast hierarchy.

At block 2316, forecast information related to at least one time series of the multiple time series may be provided, for example, to a user. In at least one example, such forecast information (e.g., optional outputs, statistics regarding each time series, clustering measurements, and the lice) may be useful for a downstream process.

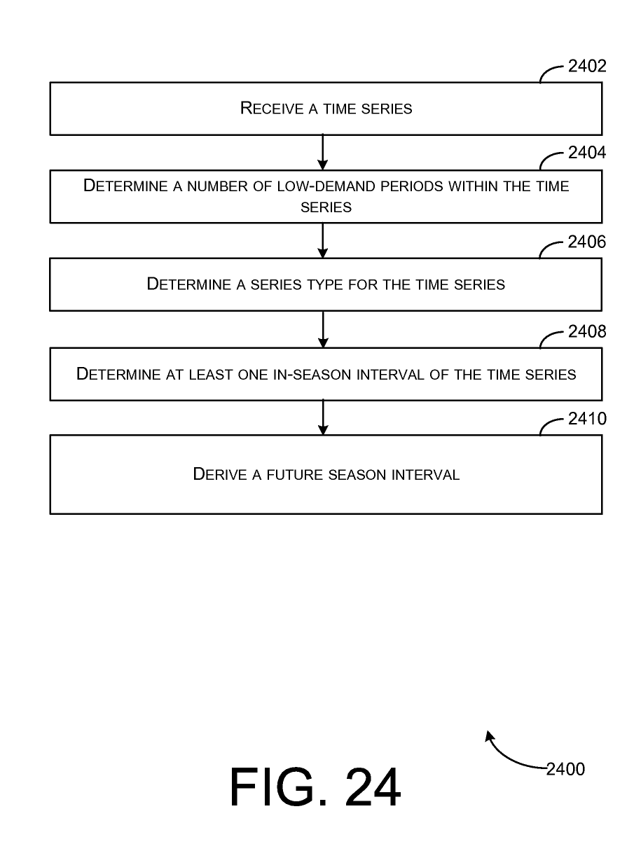

FIG. 24 illustrates an example of a flow diagram 2400 for generating a custom interval. The flow 2400 may begin at block 2402, where a time series may be received. The time series may include one or more demand characteristics and one or more demand patterns for an item (e.g., an item offered for consumption).

At block 2404, a number of low-demand periods within the time series may be determined (e.g., by custom intervals module 217 of FIG. 2). For example, periods of time for which demand is less than a threshold value may be determined. These period of time may be treated as a low-demand period. The threshold value may be non-zero.

At block 2406, custom intervals module 217 may determine a series type for the time series based on the determined low-demand period(s) from block 2404. The series type may be determined by identifying whether a demand period within the time series is above or below a seasonal threshold value. If the demand period is at or above the seasonal threshold length, then the time series' series type may be determined to be “seasonal.” If the demand period is below the seasonal threshold length, and a pre-defined event occurs during the demand period, then series type for the time series may be determined to be “event.”

At block 2408, custom intervals module 217 may determine an in-season interval of the time series based on the number of low-demand periods and the series type. The in-season interval may indicate a time interval for which the item has historically been in demand.

At block 2410 custom intervals module 217 may derive a future in-season interval based on the determined in-season interval. The future in-season interval may be a predicted time interval during which demand for the item is predicted to be greater than a threshold value.

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The system and method data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a mark language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example, semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allover the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

1. A computer-program product tangibly embodied in a non-transitory machine-readable storage medium, the computer-program product including instructions configured to be executed to cause a data processing apparatus to:
receive a time series that includes one or more demand characteristics and a demand pattern for an item;
determine a number of low-demand periods within the time series, a low-demand period being a time interval for which demand for the item is less than a threshold value;
determine a series type for the time series based on the number of low-demand periods;
determine an in-season interval of the time series based on the number of low-demand periods and the series type, the in-season interval indicating a demand period for which demand for the item has historically been greater than the threshold value; and
derive a future in-season interval based on the determined in-season interval, the future in-season interval being a predicted time interval during which demand for the item is predicted to be greater than the threshold value.

2. The computer-program product of claim 1, wherein the instructions that are configured to cause the data processing apparatus to determine the number of low-demand periods within the time series are further configured to be executed to cause the data processing apparatus to determine an approximate time series utilizing a segmentation algorithm and the time series, wherein the number of low-demand periods are determined using the approximate time series.

3. The computer-program product of claim 1, wherein the instructions configured to cause the data processing apparatus to determine the number of low-demand period include further instructions configured to be executed to cause the data processing apparatus to determine whether the demand period exceeds a threshold amount of time.

4. The computer-program product of claim 1, wherein the time series includes time series aggregated data from a plurality of time series, the plurality of time series individually comprising at least one demand characteristic and at least one demand pattern for an item.

5. The computer-program product of claim 1, including further instructions configured to be executed to cause a data processing apparatus to identify an incomplete seasonal period of the time series, the incomplete seasonal period beginning with data that is greater than the threshold value.

6. The computer-program product of claim 5, including further instructions configured to be executed to cause the data processing apparatus to exclude the incomplete seasonal period from the time series.

7. The computer-program product of claim 1, including further instructions configured to be executed to cause a data processing apparatus to:
determine a mean period for the in-season interval of the time series;
associate the time series with a seasonal series type based on a determination that the mean period is greater than a seasonal threshold amount; and
associate the time series with an event series type based on a determination that the mean period is less than the seasonal threshold amount.

8. The computer-program product of claim 1, wherein the instructions that are configured to cause the data processing apparatus to determine the in-season interval based on the number of low-demand periods and the series type are further configured to be executed to cause the data processing apparatus to receive user input selecting a calculation of at least one of a minimum period, a maximum period, a mean period, or a mode period.

9. The computer-program product of claim 7, including further instructions configured to be executed to cause a data processing apparatus to, when the time series is associated with the seasonal series type, determine a season start index corresponding to a day of a year on which a season begins, wherein determining the in-season interval is further based on the season start index and the received user input.

10. (canceled)

11. A computer-implemented method comprising:
receiving a time series that includes one or more demand characteristics and a demand pattern for an item;
determining, by a computing device, a number of low-demand periods within the time series, a low-demand period being a time interval for which demand for the item is less than a threshold value;
determining, by the computing device, a series type for the time series based on the number of low-demand periods;
determining, by the computing device, an in-season interval of the time series based on the number of low-demand periods and the series type, the in-season interval indicating a demand period for which demand for the item has historically been greater than the threshold value; and
deriving, by the computing device, a future in-season interval based on the determined in-season interval, the future in-season interval being a predicted time interval during which demand for the item is predicted to be greater than the threshold value.

12.-20. (canceled)

21. A system, comprising:
a processor; and
a non-transitory computer-readable storage medium including instructions
configured to be executed that, when executed by the processor, cause the system to perform operations including:
receiving a time series that includes one or more demand characteristics and a demand pattern for an item;
determining a number of low-demand periods within the time series, a low-demand period being a time interval for which demand for the item is less than a threshold value;
determining a series type for the time series based on the number of low-demand periods;
determining an in-season interval of the time series based on the number of low-demand periods and the series type, the in-season interval indicating a demand period for which demand for the item has historically been greater than the threshold value; and
deriving a future in-season interval based on the determined in-season interval, the future in-season interval being a predicted time interval during which demand for the item is predicted to be greater than the threshold value.

22. The system of claim 21, wherein the instructions that are, when executed by the processor, configured to cause the system to perform operations including determining the number of low-demand periods within the time series, include further instructions that are configured to, when executed by the processor, cause the system to perform operations including determining an approximate time series utilizing a segmentation algorithm and the time series, wherein the number of low-demand periods are determined using the approximate time series.

23. The system of claim 21, wherein the instructions that are, when executed by the processor, configured to cause the system to perform operations including determining the number of low-demand periods, include further instructions that are configured to, when executed by the processor, cause the system to perform operations including determining whether the time period during which demand for the item is less than the threshold value exceeds a threshold amount of time.

24. The system of claim 21, wherein the time series includes aggregated data from a plurality of time series, the plurality of time series individually comprising at least one demand characteristic and at least one demand pattern for an item offered for consumption.

25. The system of claim 21, including further instructions configured to be executed that, when executed by the processor, cause the system to perform further operations including identifying an incomplete seasonal period of the time series, the incomplete seasonal period beginning with data that is greater than the threshold value.

26. The system of claim 25, including further instructions configured to be executed that, when executed by the processor, cause the system to perform further operations including excluding the incomplete seasonal period from the time series.

27. The system of claim 21, including further instructions configured to be executed that, when executed by the processor, cause the system to perform further operations including:
determining a mean period for the at least one in-season interval of the time series;
associating the time series with a seasonal series type based on a determination that the mean period is greater than a seasonal threshold amount; and
associating the time series with an event series type based on a determination that the mean period is less than the seasonal threshold amount.

28. The system of claim 21, wherein the instructions that are, when executed by the processor, configured to cause the system to perform operations including determining the in-season interval based on the number of low-demand periods and the series type, include further instructions that are configured to, when executed by the processor, cause the system to perform operations including receiving user input selecting a calculation of at least one of a minimum period, a maximum period, a mean period, or a mode period.

29. The system of claim 27, including further instructions configured to be executed that, when executed by the processor, cause the system to perform further operations including determining, when the time series is associated with the seasonal series type, a season start index corresponding to a day of a year on which an season begins, wherein determining the in-season interval is further based on the season start index and the received user input.

30. The system of claim 28, including further instructions configured to be executed that, when executed by the processor, cause the system to perform further operations including, when the time series is associated with the event series type:
determining an event index corresponding to a day of a year on which an event occurs in the time series;
determining a season start index for the in-season interval based on the received user input and the event index; and
determining a season end index for the in-season interval based on the received user input and the event index; wherein the determined in-season interval is further based on the season start index and the season end index.
